(19) United States
(12) Patent Application Publication
(10) Pub. No.: US 2023/0017782 A1
(43) Pub. Date: Jan. 19, 2023

(54) ARTIFICIAL INTELLIGENCE SYSTEM FOR REAL-TIME CONTROL OF RESOURCE TRANSFER VOLUME

(71) Applicant: BANK OF AMERICA CORPORATION, Charlotte, NC (US)

(72) Inventor: Joseph Benjamin Castinado, North Glenn, CO (US)

(73) Assignee: BANK OF AMERICA CORPORATION, Charlotte, NC (US)

(21) Appl. No.: 17/375,399

(22) Filed: Jul. 14, 2021

(51) Int. Cl. G06Q 20/10; G06N 20/00

(52) U.S. Cl. CPC G06Q 20/102; G06Q 20/108; G06N 20/00

(57) ABSTRACT

Embodiments of the invention are directed to systems, methods, and computer program products for utilizing machine learning to predict future resource transfers and control the volume of said transfers. As such, the system allows for use of a machine learning engine to collect pending resource transfer information from a plurality of sources and predict future resource transfers associated with said sources. A single user may initiate resource transfers through a plurality of managing entities. By collecting data associated with each resource transfer, the system may identify data trends and generate predictions of future resource transfers independently of the facilitating entity. Thus, the system may benefit a number of entities, by providing real-time data analysis that would not be obtainable by any one entity operating alone. Additionally, the system may provide a single managing entity with real-time suggestions that may increase the volume of future resource transfers that the entity executes.

### BACKGROUND

Some types of resource transfers, such as wire transfers, can take hours or even days to complete. During this time, data relating to said transfers is typically not available to a managing entity system for analysis. Therefore, any insights or decisions that are dependent on said data are often delayed and reactionary in nature. As such, a need exists for a system which is able to provide a managing entity system with real-time transaction data from a plurality of sources in real-time, allowing the managing entity system to proactively manage the volume or flow of pending resource transfers.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention relate to systems, methods, and computer program products for resource transfer volume control, the invention including: receiving a resource transfer dataset from a managing entity system, where the resource transfer dataset includes data associated with a resource transfer facilitated by the managing entity system; determining, from the resource transfer dataset, a set of standard characteristics of the resource transfer; querying a database for one or more datasets matching the set of standard characteristics and appending the resource transfer dataset to the one or more datasets matching the set of standard characteristics, creating a combined dataset; processing the combined dataset via a machine learning engine to predict one or more future resource transfers; and transmitting a notification to the managing entity system, where the notification includes information associated with the one or more predicted future resource transfers.

In some embodiments, determining, from the resource transfer dataset, a set of standard characteristics of the resource transfer includes converting the data associated with the resource transfer into a standard format.

In some embodiments, determining, from the resource transfer dataset, a set of standard characteristics of the resource transfer further includes assigning the data associated with the resource transfer to one or more predetermined categories based on a calculated similarity score.

In some embodiments, the invention further includes, when processing the combined dataset via the machine learning engine, generating a machine learning dataset, where the machine learning dataset includes data identifying one or more patterns or sequences of a plurality of resource transfers.

In some embodiments, the invention includes receiving a plurality of resource transfer datasets from one or more third party managing entities, where each resource transfer dataset includes data associated with a resource transfer facilitated by the one or more third party managing entities.

In some embodiments, processing the combined dataset via the machine learning engine to predict one or more future resource transfers includes predicting an associated entity for each of the one or more future resource transfers, where the associated entity is either the managing entity system or one of the one or more third party managing entities.

In some embodiments, processing the combined dataset via the machine learning engine to predict one or more future resource transfers further includes determining a plurality of adjustments which will result in the predicted associated entity to be the managing entity system for at least one of the one or more future resource transfers.

In some embodiments, the invention further includes causing the managing entity system to execute the plurality of adjustments.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for the resource transfer volume control system, in accordance with one embodiment of the present disclosure;

FIG. 2 is a block diagram illustrating the resource transfer volume control system;

FIG. 3 is a flow diagram illustrating a process using the resource transfer volume control system, in accordance with one embodiment of the present disclosure; and

FIG. 4 is a flow diagram illustrating a process using the resource transfer volume control system, in accordance with another embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” or “managing entity” as used herein may refer to any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, or the like. The account is associated with and/or maintained by the entity. In other embodiments, an entity may not be a financial institution. In still other embodiments, the entity may be the merchant itself.

“Entity system” or “managing entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“User” as used herein may refer to an individual associated with an entity. As such, in some embodiments, the user may be an individual having past relationships, current relationships or potential future relationships with an entity. In some instances, a “user” is an individual who has a relationship with the entity, such as a customer or a prospective customer. Accordingly, as used herein the term “user device” or “mobile device” may refer to mobile phones, personal computing devices, tablet computers, wearable devices, and/or any portable electronic device capable of receiving and/or storing data therein and are owned, operated, or managed by a user.

“Transaction” or “resource transfer” as used herein may refer to any communication between a user and a third party merchant or individual to transfer funds for purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

As used herein, an “engine” may refer to core elements of a computer program, or part of a computer program that serves as a foundation for a larger piece of software and drives the functionality of the software. An engine may be self-contained, but externally-controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some embodiments, an engine may be configured to retrieve resources created in other computer programs, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

The system allows for use of a machine learning engine to collect pending resource transfer information from a plurality of sources and predict future resource transfers associated with said sources. A single user may initiate resource transfers through a plurality of managing entities or financial institutions. By collecting data associated with each resource transfer, the system may identify data trends and generate predictions of future resource transfers independently of the managing entity which may facilitate the transfer. In this way, the system may benefit a number of managing entities, by providing real-time resource transfer insights and data analysis that would not be obtainable by any one entity operating alone. Additionally, the features and functions of the system may provide a managing entity with real-time suggestions of actions that may increase the volume of future resource transfers executed by the managing entity.

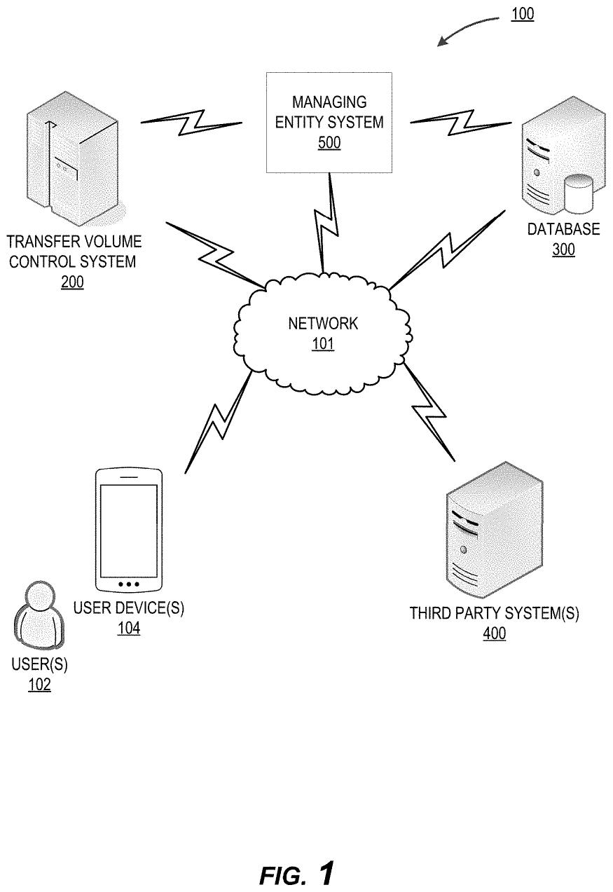

FIG. 1 illustrates an operating environment 100 for the transfer volume control system, in accordance with one embodiment of the present disclosure. As illustrated, the operating environment 100 may comprise a primary managing entity system 500 and one or more third party systems 400 (e.g., third party managing entity systems) in operative communication with one or more user device(s) 104 associated with one or more user(s) 102. The operative communication may occur via a network 101 as depicted, or the user(s) 102 may be physically present at a location associated with the primary managing entity system 500 and/or third party system(s) 400, such as a computer terminal or point-of-sale device located within a storefront. The operating environment also includes a transfer volume control system 200, a database 300, and/or other systems/devices not illustrated herein and connected via a network 101. As such, the user 102 may complete a resource transfer via the managing entity system 500 or the third party system(s) 400 by establishing operative communication channels between the user device 104 and the managing entity system 500 or third party system 400 via a wireless network 101. In other embodiments, the user may complete a resource transfer via the managing entity system 500 or the third party system(s) 400 by interfacing directly with either system.

Typically, the transfer volume control system 200 and the database 300 may be in operative communication with the managing entity system 500 and third-party system(s) 400, via the network 101, which may be the internet, an intranet or the like. In FIG. 1, the network 101 may include a local area network (LAN), a wide area network (WAN), a global area network (GAN), and/or near field communication (NFC) network. The network 101 may provide for wireline, wireless, or a combination of wireline and wireless communication between devices in the network. In some embodiments, the network 101 includes the Internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between the user device 104 and the managing entity system 500 or third party system 400). In this regard, the wireless communication channel may further comprise near field communication (NFC), communication via radio waves, communication through the internet, communication via electromagnetic waves and the like.

The user device 104 may comprise a mobile communication device, such as a cellular telecommunications device (i.e., a smart phone or mobile phone), a computing device such as a laptop computer, a personal digital assistant (PDA), a mobile internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like.

The managing entity system 500 may comprise a communication module and memory not illustrated, and may be configured to establish operative communication channels with a third party system 400 and/or a user device 104 via a network 101. The managing entity may comprise a user data repository which stores user account data. This data may be used by the managing entity to facilitate resource transfers between the user 102 or user device 104 and other users, merchants, or third-party entities (not shown). In some embodiments, the managing entity system is in operative communication with the transfer volume control system 200 and database 300 via a private communication channel. The private communication channel may be via a network 101 or the transfer volume control system 200 and database 300 may be fully integrated within the managing entity system 500.

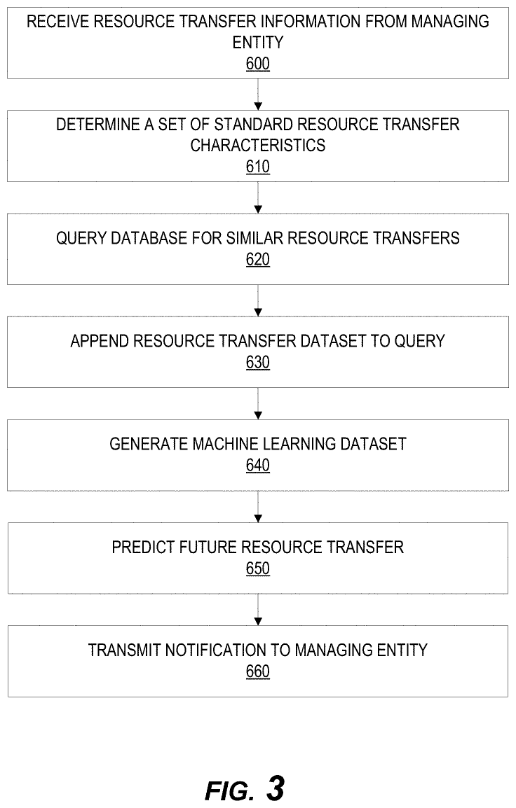

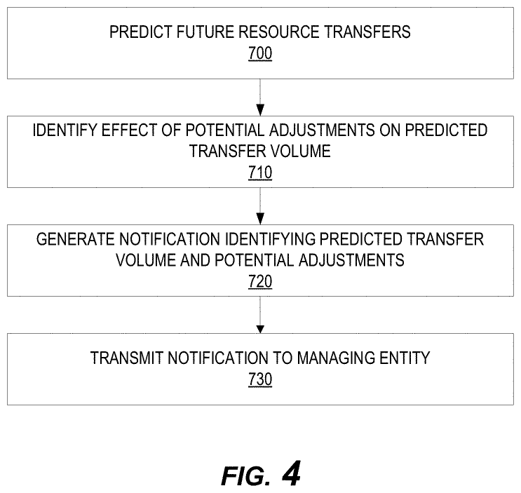

As will be discussed in greater detail in FIG. 3 and FIG. 4, the managing entity system 500 and the third party system(s) 400 may communicate with the transfer volume control system 200 in order to transmit data associated with resource transfers initiated by a plurality of users 102. In some embodiments, the managing entity may utilize the features and functions of the transfer volume control system to predict user behavior and anticipate future resource transfers. In other embodiments, the managing entity and/or the one or more third party systems may utilize the transfer volume control system to react to identified trends in future resource transfers.

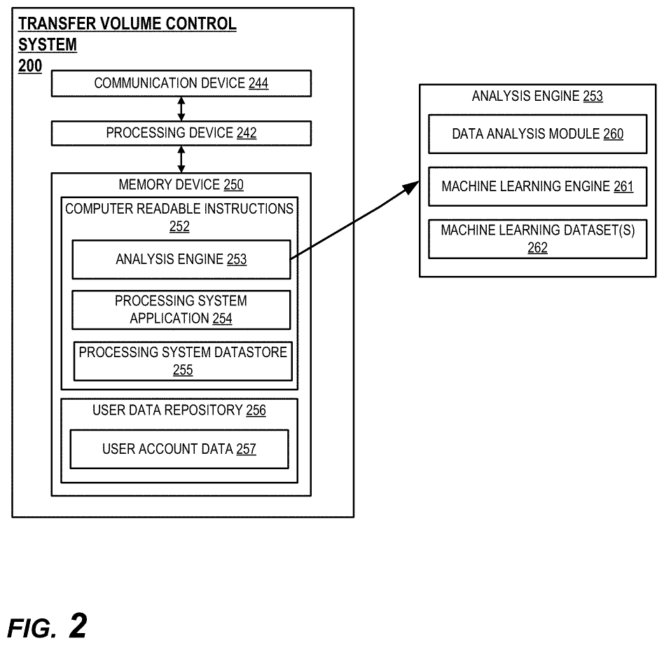

FIG. 2 illustrates a block diagram of the transfer volume control system 200 associated with the operating environment 100, in accordance with embodiments of the present invention. As illustrated in FIG. 2, the transfer volume control system 200 may include a communication device 244, a processing device 242, and a memory device 250 having an analysis engine 253, a processing system application 254 and a processing system datastore 255 stored therein. As shown, the processing device 242 is operatively connected to and is configured to control and cause the communication device 244, and the memory device 250 to perform one or more functions. In some embodiments, the analysis engine 253 and/or the processing system application 254 comprises computer readable instructions that when executed by the processing device 242 cause the processing device 242 to perform one or more functions and/or transmit control instructions to the database 300, the managing entity system 500, and/or the communication device 244. It will be understood that the analysis engine 253 and/or the processing system application 254 may be executable to initiate, perform, complete, and/or facilitate one or more portions of any embodiments described and/or contemplated herein. The analysis engine 253 may comprise executable instructions associated with data processing and analysis related to resource transfer data and may be embodied within the processing system application 254 in some instances. The transfer volume control system 200 may be owned by, operated by and/or affiliated with the same managing entity that owns or operates the managing entity system 500. In some embodiments, the transfer volume control system 200 is fully integrated within the managing entity system 500.

The analysis engine 253 may further comprise a data analysis module 260, a machine learning engine 261, and a machine learning dataset(s) 262. The data analysis module 260 may store instructions and/or data that may cause or enable the transfer volume control system 200 to receive, store, and/or analyze data received by the managing entity system 500, the database 300, and the one or more third-party system(s) 400. The data analysis module may process data to identify resource transfer characteristics as is discussed in greater detail with respect to FIG. 3. The machine learning engine 261 and machine learning dataset(s) 262 may store instructions and/or data that cause or enable the transfer volume control system 200 to determine, in real-time and based on received information, a predicted volume of resource transfers to be executed by an entity over a particular period of time. The machine learning dataset(s) 262 may contain data queried from database 300 and/or may be based on historical data relating to a particular user, third party merchant, third party managing entity, past resource transfer characteristics, and/or the like. In some embodiments, the machine learning dataset(s) 262 may also contain data relating to user activity other than resource transfers as is further described herein.

The machine learning engine 261 may receive data from a plurality of sources and, using one or more machine learning algorithms, may generate one or more machine learning datasets 262. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. Additional or alternative machine learning algorithms may be used without departing from the invention.

The machine learning datasets 262 may include machine learning data linking one or more details of a resource transfer (e.g. transfer amount, additional costs associated with the transfer, user information, recipient information, date/time information, and/or the like) with a managing entity associated with execution of the transfer to identify one or more patterns or sequences of transfers that may aid in predicting one or more future transfers by the same user or by another user with a similar transaction history. For instance, the machine learning datasets 262 may include data linking a series of historical resource transfers at particular dates/times with a likelihood of a user initiating a subsequent, similar, transfer at a predicted future date/time. Thus, this data may enable to the transfer volume control system 200 to predict a likely future resource transfer. The data associated with a resource transfer may be supplemented by additional data obtained from an interaction between the user device 104 and the managing entity system 500 or third party system(s) 400. For example, in some embodiments, the system may determine, based on data obtained from a user device 104, that a user is a likely to use a particular third party managing entity system to complete resource transfers with an international recipient. The transfer volume control system 200 may weight that information accordingly to determine when a predicted future resource transfer is more likely to be executed by the particular third party managing entity than the primary managing entity. Additionally or alternatively, the system may determine, based on a transfer cost collected by a managing entity, whether a user is likely to complete subsequent transfers with the same managing entity. The transfer volume control system 200 may weight that information accordingly to determine that a predicted resource transfer is more likely to be completed by a particular managing entity based on a particular cost of the resource transfer.

The communication device 244 may generally include a modem, server, transceiver, and/or other devices for communicating with other devices on the network 101. The communication device 244 may be a communication interface having one or more communication devices configured to communicate with one or more other devices on the network 101, such as the transfer volume control system 200, the user device(s) 104, other processing systems, data systems, etc.

Additionally, referring to transfer volume control system 200 illustrated in FIG. 2, the processing device 242 may generally refer to a device or combination of devices having circuitry used for implementing the communication and/or logic functions of the transfer volume control system 200. For example, the processing device 242 may include a control unit, a digital signal processor device, a microprocessor device, and various analog-to-digital converters, digital-to-analog converters, and other support circuits and/or combinations of the foregoing. Control and signal processing functions of the transfer volume control system 200 may be allocated between these processing devices according to their respective capabilities. The processing device 242 may further include functionality to operate one or more software programs based on computer-executable program code 252 thereof, which may be stored in a memory device 250, such as the processing system application 254 and the analysis engine 253. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 242 may be configured to use the network communication interface of the communication device 244 to transmit and/or receive data and/or commands to and/or from the other devices/systems connected to the network 101.

The memory device 250 within the transfer volume control system 200 may generally refer to a device or combination of devices that store one or more forms of computer-readable media for storing data and/or computer-executable program code/instructions. For example, the memory device 250 may include any computer memory that provides an actual or virtual space to temporarily or permanently store data and/or commands provided to the processing device 242 when it carries out its functions described herein.

In some instances, various features and functions of the invention are described herein with respect to a “system.” In some instances, the system may refer to the transfer volume control system 200 performing one or more steps described herein in conjunction with other devices and systems, either automatically based on executing computer readable instructions of the memory device 250, or in response to receiving control instructions from the managing entity system 500. In some instances, the system refers to the devices and systems on the operating environment 100 of FIG. 1. The features and functions of various embodiments of the invention are be described below in further detail.

It is understood that the servers, systems, and devices described herein illustrate one embodiment of the invention. It is further understood that one or more of the servers, systems, and devices can be combined in other embodiments and still function in the same or similar way as the embodiments described herein.

FIG. 3 is a high-level process flow diagram illustrating a process using the transfer volume control system, in accordance with one embodiment of the present disclosure. The process begins at block 600, where the system receives a data packet from a managing entity system 500 or a third party managing entity system 400, wherein the data packet contains information characterizing a resource transfer. The resource transfer information contained within the data packet may include but is not limited to data such as time, location, description of a product/service, resource amount, resource instrument or account used to complete the transfer, any additional costs collected by the managing entity that executed the transfer, information identifying the transfer recipient, and/or information identifying the user that initiated the transfer. In some embodiments the system may receive a unique data packet after each occurrence of an individual transfer, or in other embodiments the managing entity may choose to group data packets together and transfer the information after a predetermined amount of time, such as once per hour. In some embodiments, the system may simultaneously receive data from a plurality of managing entity systems, including a primary managing entity and one or more third party managing entities. Additionally or alternatively, the system may receive resource transfer information directly from one or more user device(s) 104.

The process may then continue to block 610, wherein for each individual resource transfer, the system determines a set of standard characteristics from the information associated with the resource transfer (e.g., via the data analysis module 260). Standard characteristics may include any type of information included in a received data packet and may be normalized, via the data analysis module, depending on the specific formatting used by each entity that transmits data. For example, in some embodiments, a primary managing entity may include in each data packet a percentage amount of the resource transfer total that was collected as an additional cost. A second managing entity may include in each data packet a dollar amount that was collected as an additional cost. Thus, the data analysis module 260 may convert the dollar amounts received from the second managing entity into percentages in order to create a standard characteristic of “additional cost collected.” In some embodiments, standard characteristics such as recipient category (e.g. large entity, small entity, individual, etc.) may be assigned based on a calculated similarity score to one of a plurality of predetermined categories.

The process may then continue to block 620, wherein the system may query the database 300 for datasets of resource transfers with similar standard characteristics as the newly received resource transfer information. In some embodiments, the system may query for a larger selection of resource transfers, such as all resource transfers within a particular geographic area, within a particular date range, or the like. The system may then append the resource transfer dataset to the queried data 630 and process the combined data via the machine learning engine 261.

In block 640 of FIG. 3, the output of the machine learning engine is a newly generated machine learning dataset 262. As previously described, the newly generated machine learning dataset may be used to link one or more details of a resource transfer (e.g. transfer amount, additional costs associated with the transfer, user information, recipient information, date/time information, and/or the like) with a managing entity associated with execution of the transfer. This data may enable the system to identify one or more patterns or sequences of transfers, then predict a likely future transfer between a user and the managing entity system or a third party managing entity system as shown in block 650. In block 660 of FIG. 3, the system may transmit a notification to the managing entity system, wherein the notification may contain predictions generated by the transfer volume control system 200. In some embodiments, the system may transmit this notification in the form of a regularly generated report. Additionally, or alternatively, the system may transmit this notification in response to a query from the managing entity.

FIG. 4 is a high-level process flow diagram illustrating a process using the transfer volume control system, in accordance with another embodiment of the present disclosure. The process begins at block 700, wherein the system predicts a series of future resource transfers. As previously discussed, the system may utilize the machine learning engine 261 to determine that a particular volume of resource transfers will be initiated through particular third party managing entity systems based on historical data of a plurality of users, historical data of similar resource transfers, and/or the like. The system may then use the analysis engine 253 to determine one or more adjustments that, if executed by the primary managing entity system, would cause the predicted resource transfers to be more likely to involve the managing entity system rather than one of the originally predicted third party systems. For example, the system may determine that if the amount of additional cost collected by the managing entity system per transfer was lowered by 1%, then an additional 10% of the volume of predicted resource transfers would involve the managing entity system rather than another third party system. In another example, the system may determine that if the managing entity system decreased the time required to complete an international resource transfer by one day, then an additional 15% of the volume of predicted international resource transfers would involve the managing entity system rather than another third party system.

In some embodiments, the system may utilize the machine learning engine 261 to calculate the degree to which each potential adjustment may influence the volume of resource transfers and then weight a list of adjustments according to the probability of each adjustment increasing the overall volume of resource transfers involving the primary managing entity.

The process continues in block 720, wherein the system may generate a notification or data packet containing details of the predicted transfers, as well as the list of potential adjustments determined in block 710. The message may contain information such as predicted times and/or dates of the transfers, the resource instruments and/or accounts to be utilized by the users, information identifying the users, information identifying the recipients, and/or information identifying the involved third party managing entity systems. The process is completed in block 730, wherein the system transmits that notification to the managing entity system. Additionally or alternatively, in embodiments wherein the system is fully integrated into the managing entity system, the system may automatically cause the managing entity system to execute the list of adjustments, allowing the volume of resource transfers to be manipulated in real time.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for resource transfer volume control, the system comprising:
at least one non-transitory storage device; and
at least one processing device coupled to the at least one non-transitory storage device, wherein the at least one processing device is configured to:
automatically receive, via a network, a resource transfer dataset from a managing entity system, wherein the resource transfer dataset comprises data associated with a resource transfer facilitated by the managing entity system;
convert the data associated with the resource transfer into standardized data;
determine, from the standardized data, a set of standard characteristics of the resource transfer;
query a database for one or more datasets matching the set of standard characteristics and append the resource transfer dataset to the one or more datasets matching the set of standard characteristics, creating a combined dataset;
process the combined dataset via a machine learning engine to predict one or more future resource transfers; and
transmit, via the network, a notification to the managing entity system, wherein the notification comprises information associated with the one or more predicted future resource transfers.

2. (canceled)

3. The system of claim 2, wherein determining, from the standardized data a set of standard characteristics of the resource transfer further comprises assigning the data associated with the resource transfer to one or more predetermined categories based on a calculated similarity score.

4. The system of claim 1, wherein the at least one processing device is further configured to, when processing the combined dataset via the machine learning engine, generate a machine learning dataset, wherein the machine learning dataset comprises data identifying one or more patterns or sequences of a plurality of resource transfers.

5. The system of claim 1, wherein the at least one processing device is further configured to receive a plurality of resource transfer datasets from one or more third party managing entities, wherein each resource transfer dataset comprises data associated with a resource transfer facilitated by the one or more third party managing entities.

6. The system of claim 5, wherein processing the combined dataset via the machine learning engine to predict one or more future resource transfers comprises predicting an associated entity for each of the one or more future resource transfers, wherein the associated entity is either the managing entity system or one of the one or more third party managing entities.

7. The system of claim 6, wherein processing the combined dataset via the machine learning engine to predict one or more future resource transfers further comprises determining a plurality of adjustments which will result in the predicted associated entity to be the managing entity system for at least one of the one or more future resource transfers.

8. The system of claim 7, wherein the at least one processing device is further configured to cause the managing entity system to execute the plurality of adjustments.

9. A computer program product for resource transfer volume control, the computer program product comprising at least one non-transitory computer-readable medium having computer-readable program code portions embodied therein, the computer-readable program code portions comprising:
an executable portion configured for automatically receiving, via a network, a resource transfer dataset from a managing entity system, wherein the resource transfer dataset comprises data associated with a resource transfer facilitated by the managing entity system;
an executable portion configured for converting the data associated with the resource transfer into standardized data;
an executable portion configured for determining, from the standardized data, a set of standard characteristics of the resource transfer;
an executable portion configured for querying a database for one or more datasets matching the set of standard characteristics and appending the resource transfer dataset to the one or more datasets matching the set of standard characteristics, creating a combined dataset;
an executable portion configured for processing the combined dataset via a machine learning engine to predict one or more future resource transfers; and
an executable portion configured for transmitting, via a network, a notification to the managing entity system, wherein the notification comprises information associated with the one or more predicted future resource transfers.

10. (canceled)

11. The computer program product of claim 10, wherein determining, from the standardized data, a set of standard characteristics of the resource transfer further comprises assigning the data associated with the resource transfer to one or more predetermined categories based on a calculated similarity score.

12. The computer program product of claim 9, further comprising an executable portion configured for, when processing the combined dataset via the machine learning engine, generating a machine learning dataset, wherein the machine learning dataset comprises data identifying one or more patterns or sequences of a plurality of resource transfers.

13. The computer program product of claim 9, further comprising an executable portion configured for receiving a plurality of resource transfer datasets from one or more third party managing entities, wherein each resource transfer dataset comprises data associated with a resource transfer facilitated by the one or more third party managing entities.

14. The computer program product of claim 13, wherein processing the combined dataset via the machine learning engine to predict one or more future resource transfers comprises predicting an associated entity for each of the one or more future resource transfers, wherein the associated entity is either the managing entity system or one of the one or more third party managing entities.

15. The computer program product of claim 14, wherein processing the combined dataset via the machine learning engine to predict one or more future resource transfers further comprises determining a plurality of adjustments which will result in the predicted associated entity to be the managing entity system for at least one of the one or more future resource transfers.

16. The computer program product of claim 15, further comprising an executable portion configured for causing the managing entity system to execute the plurality of adjustments.

17. A computer-implemented method for resource transfer volume control, the method comprising:
providing a computing system comprising a computer processing device and a non-transitory computer readable medium, wherein the computer readable medium comprises configured computer program instruction code, such that when said instruction code is operated by said computer processing device, said computer processing device performs the following operations:
automatically receiving, via a network, a resource transfer dataset from a managing entity system, wherein the resource transfer dataset comprises data associated with a resource transfer facilitated by the managing entity system;
converting the data associated with the resource transfer into standardized data;
determining, from the standardized data, a set of standard characteristics of the resource transfer;
querying a database for one or more datasets matching the set of standard characteristics and appending the resource transfer dataset to the one or more datasets matching the set of standard characteristics, creating a combined dataset;
processing the combined dataset via a machine learning engine to predict one or more future resource transfers; and
transmitting, via a network, a notification to the managing entity system, wherein the notification comprises information associated with the one or more predicted future resource transfers.

18. The computer-implemented method of claim 17, wherein determining, from the standardized data, a set of standard characteristics of the resource transfer comprises assigning the data associated with the resource transfer to one or more predetermined categories based on a calculated similarity score.

19. The computer-implemented method of claim 17, further comprising receiving a plurality of resource transfer datasets from one or more third party managing entities, wherein each resource transfer dataset comprises data associated with a resource transfer facilitated by the one or more third party managing entities.

20. The computer-implemented method of claim 19, wherein processing the combined dataset via the machine learning engine to predict one or more future resource transfers comprises predicting an associated entity for each of the one or more future resource transfers, wherein the associated entity is either the managing entity system or one of the one or more third party managing entities, and determining a plurality of adjustments which will result in the predicted associated entity to be the managing entity system for at least one of the one or more future resource transfers.
